(19) United States
(12) Patent Application Publication
(10) Pub. No.: US 2018/0368228 A1
(43) Pub. Date: Dec. 20, 2018

(54) METHOD AND DEVICE FOR MANAGING THE OPERATION OF A LIGHTING DEVICE

(71) Applicant: DELTA DORE, Bonnemain (FR)

(72) Inventors: Laurent POUJAUD, Bonnemain (FR); Guillaume LEGROS, Bonnemain (FR)

(21) Appl. No.: 16/061,864

(22) PCT Filed: Dec. 13, 2016
(86) PCT No.: PCT/EP2016/080806

§ 371 Date: Jun. 13, 2018

(30) Foreign Application Priority Data
Dec. 14, 2015 (FR) 1562284

(51) Int. Cl. H05B 33/08; H05B 37/02; H02M 5/257

(52) U.S. Cl. CPC H05B 33/0845; H02M 5/2573; H05B 37/02; H05B 33/0806

(57) ABSTRACT

The invention relates to a method and to a device for managing the operation of a lighting device (Lp) having capacitive impedance, the lighting device being supplied by an AC electric power supply network, the management device comprising means (SW1, SW2) for varying the duration of the supply of electric power to the lighting device upon each alternation of the electrical signal supplied by the AC electric power supply network, at least one resistor (R1, R2) for discharging the electric power stored by the lighting device, characterized in that the management device (10) comprises means for allowing the electric power stored in the lighting device to be discharged only when electric power is not supplied to the lighting device.

The present invention relates to a method and to a device for managing the operation of a lighting device having capacitive impedance.

Currently, the possibility of being able to regulate the luminous intensity of lighting devices is an important requirement for users. The lighting devices are supplied, for example, by a domestic electric power supply network supplying a voltage of 110 or 230 Volts at a frequency of 50 or 60 Hz.

Conventionally, regulators only supply the lighting devices with voltage during part of each alternation of the domestic electric power supply network. By varying the duration of the supply of electric power, the supplied electric power varies and the luminous intensity varies.

The electronics used in the regulators are triac or MOS transistor based. These components allow the sine wave to be interrupted in order to vary the voltage on the terminals of the lighting devices. These regulators can be installed in encased units or on electrical panels. They can be controlled by a pushbutton or by radio control. These regulators can control bulbs of the resistive, inductive and capacitive type, either directly or through an electronic or inductive transformer in the case of low-voltage bulbs.

The various regulator manufacturers encounter problems with lighting devices in which the impedance is mainly capacitive, such as lighting devices using light-emitting diodes (LED). Interrupting the sine wave becomes more difficult to implement with such lighting devices. The control electronics can easily increase the supply of electric power but are less efficient when the supply of electric power has to be reduced. Capacitive impedance accumulates an electric charge that needs to be discharged if the intention is to reduce the luminous intensity under reasonable conditions for a user. The control electronics do not allow the electric charge to be discharged. This often manifests as a very limited luminous variation range compared to lighting systems having resistive impedance.

Some regulator manufacturers propose a solution that involves placing a resistive load outside the regulator parallel to the lighting device so as to be able to discharge the internal capacitances of the lighting device.

The main problem of this solution lies in the loss of power generated by this resistive load during the duration of supplying the lighting device with electric power.

Users of such lighting devices generally select light-emitting diode based lighting devices in order to reduce electric power consumption. The loss of electric power associated with the use of a resistor therefore is contrary to their requirements.

Furthermore, this lost electric power is dissipated as heat by the resistor, which then becomes a hot spot. If the regulator is installed with the resistor in a confined environment, as is often the case, the heat dissipation of the resistor increases the regulator temperature and can cause it to malfunction and/or limit its lifetime.

Given the high temperature of the resistor, integrating the resistor in the vicinity of or inside the regulator is not recommended. Therefore, the installer has to find an available place for housing this resistor.

The aim of the present invention is to overcome the disadvantages of the prior art by proposing a method and a device for managing the operation of a lighting device having capacitive impedance that prevents significant losses of electric power and which is easy to install.

To this end, according to a first aspect, the invention proposes a method for managing the operation of a lighting device having capacitive impedance, the lighting device being supplied by an AC electric power supply network and comprising at least one resistor for discharging the electric power stored by the lighting device, the method comprising a step of varying the duration of the supply of electric power to the lighting device upon each alternation of the electrical signal supplied by the AC electric power supply network, characterized in that the method comprises a step of discharging the electric power stored in the lighting device only when electric power is not supplied to the lighting device.

The present invention further relates to a device for managing the operation of a lighting device having capacitive impedance, the lighting device being supplied by an AC electric power supply network, the management device comprising means for varying the duration of the supply of electric power to the lighting device upon each alternation of the electrical signal supplied by the AC electric power supply network, at least one resistor for discharging the electric power stored by the lighting device, characterized in that the management device comprises means for allowing the electric power stored in the lighting device to be discharged only when electric power is not supplied to the lighting device.

Thus, the present invention prevents the significant electric power losses. As the at least one resistor is only connected when electric power is not supplied to the lighting device, no electric power delivered by the AC electric power supply network is lost.

Due to the low dissipation of the at least one resistor, the resistor can be integrated in the management device, thus simplifying the installation thereof.

According to a particular embodiment of the invention, the management device comprises two resistors.

Thus, it is possible to use resistors with reduced maximum power and overall dimensions.

According to a particular embodiment of the invention, the means for varying the duration of the supply of electric power to the lighting device upon each alternation of the electrical signal supplied by the AC electric power supply network comprise at least two switches and the means for allowing the electric power stored in the lighting device to be discharged only when electric power is not supplied to the lighting device allow the electric power stored in the lighting device to be discharged at a predetermined time after the conduction of the two switches.

Thus, the present invention prevents the significant electric power losses.

According to a particular embodiment of the invention, the means for varying the duration of the supply of electric power to the lighting device upon each alternation of the electrical signal supplied by the AC electric power supply network, the at least one resistor for discharging the electric power stored by the lighting device and the means for allowing the electric power stored in the lighting device to be discharged only when electric power is not supplied to the lighting device are stored in the same casing.

Thus, the manufacture of the management device is facilitated, as is its installation.

The aforementioned features of the invention, as well as other features, will become more clearly apparent upon reading the following description of an embodiment, said description being provided with reference to the accompanying drawings, in which:

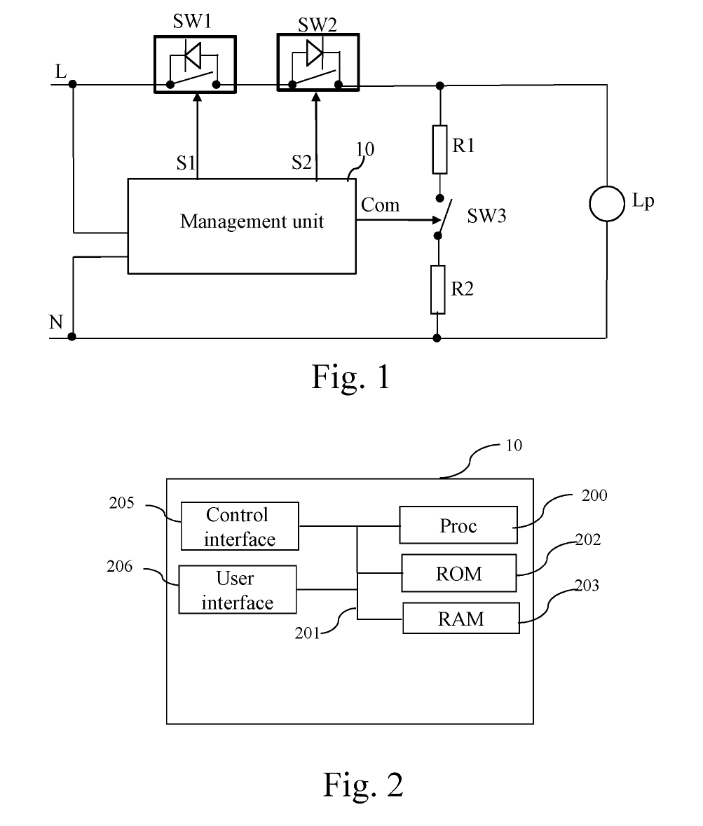

FIG. 1 shows a system for managing the operation of a lighting device with mainly capacitive impedance;

FIG. 2 shows an example of an architecture of a unit for managing the operation of a lighting device with mainly capacitive impedance;

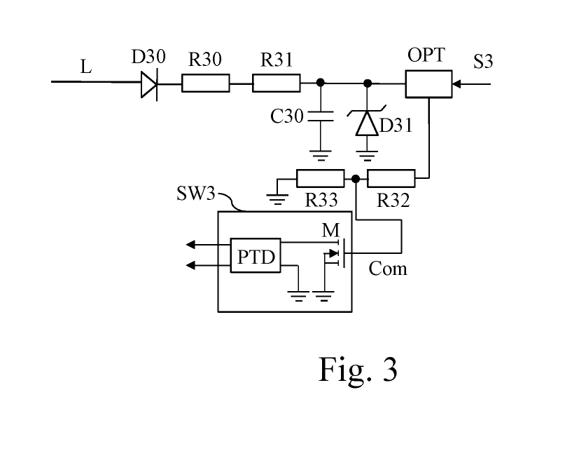

FIG. 3 shows an example of an architecture of an interface for controlling the discharging of the power stored by a lighting device with mainly capacitive impedance;

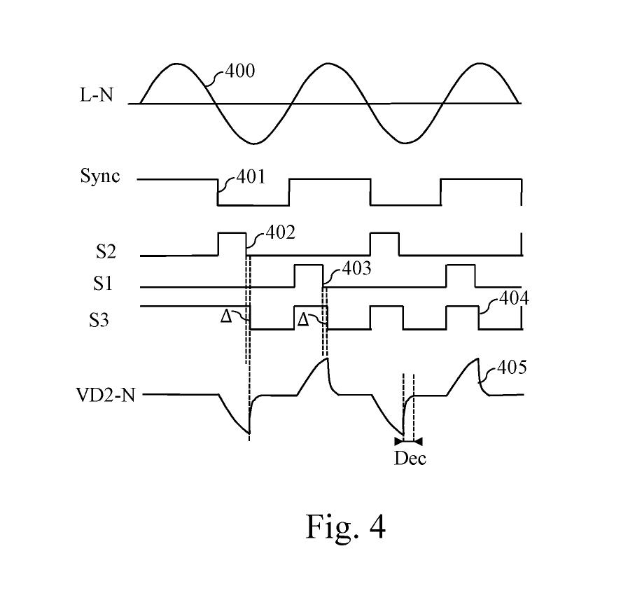

FIG. 4 shows an example of the various signals used to manage the operation of a lighting device with mainly capacitive impedance.

FIG. 1 shows a system for managing the operation of a lighting device with mainly capacitive impedance.

The system comprises an operation management unit 10 connected to the phase L and the neutral N of an AC electric power supply network. For example, the electric power supply network is a domestic network supplying a voltage of 110 or 230 Volts at a frequency of 50 or 60 Hz.

The operation management unit 10 generates control signals, denoted S1, S2, for varying the supply of electric power to the lighting device Lp according to a setpoint given by a user, for example, by means of a wireless remote control or a pushbutton.

The lighting device Lp is formed by at least one light emitting diode, the electronics of which have capacitive impedance or, more specifically, mainly capacitive impedance if the input resistances and inductances of the lighting device Lp are taken into account. The lighting device Lp comprises means for transforming electrical signals delivered to the lighting device into voltages compatible with those required for the proper operation of the at least one light-emitting diode. These transformation means are formed by at least one transformer, for example.

The control signal S1 controls the opening and closing of a switch, denoted SW1. The switch SW1 is a two-way switch formed by a bipolar or MOS transistor and a diode.

The control signal S2 controls the opening and closing of a switch, denoted SW2.

The switch SW2 is a two-way switch formed by a bipolar or MOS transistor and a diode.

The operation management unit 10 generates, according to the present invention, a control signal, denoted Com, that places at least one resistor R1 and/or R2 parallel or non-parallel to the lighting device Lp.

The control signal Com controls the opening and closing of a switch, denoted SW3.

The switch SW3 is, for example, a triac or a MOS transistor or a bipolar transistor.

A first termination of the switch SW1 is connected to the phase L and a second termination of the switch SW1 is connected to a first termination of the switch SW2. A second termination of the switch SW2 is connected to a first termination of a resistor, denoted R1, as well as to a first termination of the lighting device Lp.

A second termination of the resistor R1 is connected to a first termination of the switch SW3.

A second termination of the switch SW3 is connected to a first termination of the resistor R2.

A second termination of the resistor R2 is connected to a second termination of the lighting device Lp and to the neutral N.

It is to be noted herein that one of the resistors R1 or R2 can be replaced by a shunt.

According to the present invention, the device for managing the operation of a lighting device having capacitive impedance comprises:
means for varying the duration of the supply of electric power to the lighting device upon each alternation of the electrical signal supplied by the AC electric power supply network;
at least one resistor for discharging the electric power stored by the lighting device;
means for allowing the electric power stored in the lighting device to be discharged only when electric power is not supplied to the lighting device.

FIG. 2 shows an example of an architecture of a unit for managing the operation of a lighting device with mainly capacitive impedance.

The operation management unit 10 comprises:
a processor, microprocessor or microcontroller 200;
a volatile memory 203;
a non-volatile memory 202, such as a Flash memory;
an interface for controlling the discharging of the stored power by 205;
a user interface 206;
a communication bus connecting the processor 200 to the ROM memory 203, to the RAM memory 203, to the user interface 206 and to the control interface 205.

The processor 200 is capable of executing instructions loaded into the non-volatile memory 202 or into the volatile memory 203 from the non-volatile memory 202, from an external memory (not shown), from a storage medium, such as an SD card or other, or from a communication network. When the operation management unit 10 is powered up, the processor 200 is capable of reading and executing instructions from the non-volatile memory 202 or from the volatile memory 203. These instructions form a computer program that causes all or part of the method according to the present invention to be implemented by the processor 200.

All or part of the method according to the present invention can be implemented in software form by executing a set of instructions using a programmable machine, such as a DSP (Digital Signal Processor) or a microcontroller or can be implemented in hardware form by a dedicated machine or component, such as an FPGA (Field-Programmable Gate Array) or an ASIC (Application-Specific Integrated Circuit).

The user interface 206 is a radio interface capable of receiving commands from a wireless remote control for varying the luminous intensity of the lighting device LP or a wired interface capable of receiving commands from a pushbutton for varying the luminous intensity of the lighting device LP.

FIG. 3 shows an example of an architecture of an interface for controlling the discharging of the power stored by a lighting device with mainly capacitive impedance.

The anode of the diode D30 is connected to the phase L. The cathode of the diode D30 is connected to a first termination of a resistor R30. A second termination of the resistor R30 is connected to a first termination of a resistor R31. A second termination of the resistor R31 is connected to a first termination of a capacitor C30 and to the cathode of a Zener diode D31.

The second termination of the capacitor C30 and the anode of the Zener diode D31 are connected to the ground. The diodes D30, D31, the resistors R30 and R31 and the capacitor C30 generate a direct voltage equal to 6.2 Volts, for example.

The cathode of the Zener diode D31 is connected to a first termination of an optocoupler OPT. The optocoupler OPT is controlled from the signal S3 delivered by the control interface 205. When the signal S3 is at a high level, no current can pass between the first connection of the optocoupler OPT and a second connection of the optocoupler OPT.

When the signal S3 is at a low level, a current can pass between the first connection of the optocoupler OPT and the second connection of the optocoupler OPT.

The second connection of the optocoupler OPT is connected to a resistor R32. A second termination of the resistor R32 is connected to a first termination of a resistor R33 and to the gate of a MOS transistor M. A second termination of the resistor R33 is connected to the ground.

The resistor R33 allows the gate of the MOS transistor M to be grounded when the optocoupler OPT does not conduct.

The drain of the MOS transistor M is connected to a first termination of a diode bridge PTD. A second termination of the diode bridge and the source of the MOS transistor M are connected to the ground. A third termination of the diode bridge is connected to the second termination of the resistor R1 of FIG. 1 and a fourth termination of the diode bridge is connected to the first termination of the resistor R2 of FIG. 1.

The MOS transistor M and the diode bridge PTD form the switch SW3 of FIG. 1.

FIG. 4 shows an example of the various signals used to manage the operation of a lighting device with mainly capacitive impedance.

The signal denoted 400 is the voltage difference between the phase L and the neutral N.

The sync signal denoted 401 represents a logic signal for synchronization with the passage to the null value of the signal 400.

The signals S1 and S2, respectively denoted 403 and 402, are the control signals applied to the switches SW1 and SW2, respectively. A low logic level corresponds to the opening of the switch and a high logic level corresponds to the conduction of the switch.

The signal S3 is the control signal used to control the switch SW3. A high logic level corresponds to the opening of the switch SW3 and to not placing the resistor R1 or R2 or the resistors R1 and R2 parallel to the lighting device Lp and a low logic level corresponds to the conduction of the switch SW3 and to placing the resistor R1 or R2 or the resistors R1 and R2 parallel to the lighting device Lp in order to discharge the power stored therein.

The signal VD2-N, denoted 405, corresponds to the voltage applied to the terminals of the lighting device Lp.

The delay denoted Δ is a delay that ensures that the resistor R1 or R2 or the resistors R1 and R2 are not placed parallel to the lighting device Lp when electric power is supplied to the lighting device.

The duration denoted Dec corresponds to the duration during which the electric power stored by the lighting device discharges through the resistor R1 or R2 or the resistors R1 and R2.

Of course, the present invention is by no means limited to the embodiments described herein, but, on the contrary, it encompasses any variation within the abilities of a person skilled in the art.

1. A device for managing the operation of a lighting device having capacitive impedance, the lighting device being supplied by an AC electric power supply network, the management device comprising means for varying the duration of the supply of electric power to the lighting device upon each alternation of the electrical signal supplied by the AC electric power supply network, at least one resistor for discharging the electric power stored by the lighting device, wherein the management device comprises means for allowing the electric power stored in the lighting device to be discharged only when electric power is not supplied to the lighting device, the means for varying the duration of the supply of electric power to the lighting device upon each alternation of the electrical signal supplied by the AC electric power supply network comprising at least two switches, that the means for allowing the electric power stored in the lighting device to be discharged only when electric power is not supplied to the lighting device allow the electric power stored in the lighting to be discharged device after the end of the conduction of the two switches and after a predetermined delay following the end of the conduction of the two switches.

2. The management device as claimed in claim 1, wherein the management device comprises two resistors.

3. The management device as claimed in claim 1, wherein the means for varying the duration of the supply of electric power to the lighting device upon each alternation of the electrical signal supplied by the AC electric power supply network, the at least one resistor for discharging the electric power stored by the lighting device and the means for allowing the electric power stored in the lighting device to be discharged only when electric power is not supplied to the lighting device are stored in the same casing.

4. A method for managing the operation of a lighting device having capacitive impedance, the lighting device being supplied by an AC electric power supply network and comprising at least one resistor for discharging the electric power stored by the lighting device, the method comprising a step of varying the duration of the supply of electric power to the lighting device upon each alternation of the electrical signal supplied by the AC electric power supply network, wherein the method comprises a step of discharging the electric power stored in the lighting device only when electric power is not supplied to the lighting device, the variation of the duration of the supply of electric power to the lighting device upon each alternation of the electrical signal supplied by the AC electric power supply network is obtained from at least two switches, and discharging the electric power stored in the lighting device only when electric power is not supplied to the lighting device allows the electric power stored in the lighting device to be discharged after the end of the conduction of the two switches and after a predetermined delay following the end of the conduction of the two switches.
